(19) United States
(12) Patent Application Publication
(10) Pub. No.: US 2014/0307525 A1
(43) Pub. Date: Oct. 16, 2014

(54) DRONE SEISMIC SENSING METHOD AND APPARATUS

(71) Applicant: CGG Services SA, Massy Cedex (FR)

(72) Inventors: Jean-Jacques Postel, Boulogne Billancourt (FR); Thomas Bianchi, Paris (FR); Jonathan Grimsdale, Orsay (FR)

(73) Assignee: CGG Services SA, Massy Cedex (FR)

(21) Appl. No.: 14/220,996

(22) Filed: Mar. 20, 2014

Related U.S. Application Data
(60) Provisional application No. 61/810,403, filed on Apr. 10, 2013.

(51) Int. Cl. G01V 1/20; G01V 1/24

(52) U.S. Cl. CPC G01V 1/20; G01V 1/24
USPC 367/37

(57) ABSTRACT

An apparatus for automated seismic sensing includes a seismic sensing device for sensing seismic vibrations, a robotic transport unit for transporting the seismic sensing device to a targeted location, an engagement unit for placing the seismic sensing device in vibrational communication with the ground, and a recording module for recording the seismic data generated by the seismic sensing device. A corresponding method for automated seismic sensing includes transporting a seismic sensing device to a targeted location with a robotic transport device, determining a coupling metric for the seismic sensing device and the ground at a plurality of locations proximate to the targeted location, determining an acceptable location for seismic sensing, placing the seismic sensing device in vibrational communication with the ground at the acceptable location, and sensing seismic data with the seismic sensing device at the acceptable location.

### CROSS-REFERENCE TO RELATED APPLICATIONS

The present application is related to, and claims the benefit of priority of, U.S. Provisional Application 61/810,403, entitled “DRONE SEISMIC SENSOR,” and filed on 10 Apr. 2013, the entire content of which is incorporated herein by reference.

### BACKGROUND

1. Technical Field

Embodiments of the subject matter disclosed herein generally relate to the field of geophysical data acquisition and processing. In particular, the embodiments disclosed herein relate to apparatuses, methods, and systems for automated collection of geophysical data.

2. Discussion of the Background

Geophysical data is useful for a variety of applications such as weather and climate forecasting, environmental monitoring, agriculture, mining, hydrocarbon exploration and hydrocarbon extraction. As the economic benefits of such data have been proven, and additional applications for geophysical data have been discovered and developed, the demand for localized, high-resolution, and cost-effective geophysical data has greatly increased. This trend is expected to continue.

For example, seismic data acquisition and processing may be used to generate a profile (image) of the geophysical structure underground (either on land or seabed). While this profile does not provide an exact location for oil and gas reservoirs, it suggests, to those trained in the field, the presence or absence of such reservoirs. Thus, providing a high-resolution image of the subsurface of the earth is important, for example, to those who need to determine where oil and gas reservoirs are located.

Traditionally, a land seismic survey system 10 capable of providing a high-resolution image of the subsurface of the earth is generally configured as illustrated in FIG. 1 (although many other configurations are used). System 10 includes plural receivers 12 and acquisition units 12a positioned over an area 13 of a subsurface to be explored and in contact with the surface 14 of the ground. A number of seismic sources 16 are also placed on surface 14 in an area 17, in a vicinity of area 13 of receivers 12. A recording device 18 is connected to a plurality of receivers 12 and placed, for example, in a station-truck 20. Each source 16 may be composed of a variable number of vibrators or explosive devices, and may include a local controller 22. A central controller 24 may be present to coordinate the shooting times of the sources 16. A GPS system 26 may be used to time-correlate sources 16 and receivers 12 and/or acquisition units 12a.

With this configuration, the sources 16 are controlled to generate seismic waves, and the receivers 12 record the waves reflected by the subsurface. The receivers 12 and acquisition units 12a may be connected to each other and the recording devices with cables 30. Alternately, the receivers 12 and acquisition units 12a can be paired as autonomous nodes that do not need the cables 30.

The purpose of seismic imaging is to generate high-resolution images of the subsurface from acoustic reflection measurements made by the receivers 12. Conventionally, as shown in FIG. 1, the plurality of seismic sources and receivers is distributed on the ground surface at a distance from each other. The sources 16 are activated to produce seismic waves that travel through the subsoil. These seismic waves undergo deviations as they propagate. They are refracted, reflected, and diffracted at the geological interfaces of the subsoil. Certain waves that have travelled through the subsoil are detected by the seismic receivers 12 and are recorded as a function of time in the form of signals (called traces).

Conventionally, the sources 16 and the receivers 12 are placed and moved by members of a field crew according to a “shooting plan” for the survey. Each member of the crew may be required to follow specific instructions as to the time interval that each source and receiver is required to remain at a particular location.

In many surveys, the sources 16 and the receivers 12 are moved (i.e., “rolled”) from locations at a trailing edge of the survey area 13 to locations at a leading edge. Moving the sources and receivers in the described manner provides a high-density grid of source locations and recording locations over a large area with a limited number of sources 16 and receivers 12. However, making the required movements is labor intensive and often tedious. Furthermore, in some seismic surveys impulsive sources with explosive charges may be used that present a potential safety hazard to members of the field crew.

Due to at least the foregoing, there is a need for apparatuses, methods, and systems for automated collection of geophysical data.

### SUMMARY

As detailed herein, an apparatus for automated seismic sensing includes a seismic sensing device for sensing seismic vibrations, a robotic transport unit for transporting the seismic sensing device to a targeted location, an engagement unit for placing the seismic sensing device in vibrational communication with the ground, and a recording module for recording the seismic data generated by the seismic sensing device. A corresponding method for automated seismic sensing includes transporting a seismic sensing device to a targeted location with a robotic transport device, determining a coupling metric for the seismic sensing device and the ground at a plurality of locations proximate to the targeted location, determining an acceptable location for seismic sensing, placing the seismic sensing device in vibrational communication with the ground at the acceptable location, and sensing seismic data with the seismic sensing device at the acceptable location.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram depicting a traditional land seismic survey system;

FIGS. 2a-2d are schematic diagrams depicting various embodiments of a drone seismic sensing apparatus;

FIGS. 3a and 3b are flowchart diagrams of two embodiments of a drone seismic sensing method; and

FIG. 4 is a flowchart diagram of a launch and recovery route planning method for drone executed geophysical surveys;

FIGS. 5a-5c are schematic illustrations depicting example results for the route planning method of FIG. 4 for various environmental conditions;

FIG. 6 is a schematic illustration of various high-density local-area survey patterns for drone seismic sensors; and

FIG. 7 is a schematic illustration of one example of a high-density large-area survey pattern for drone seismic sensors.

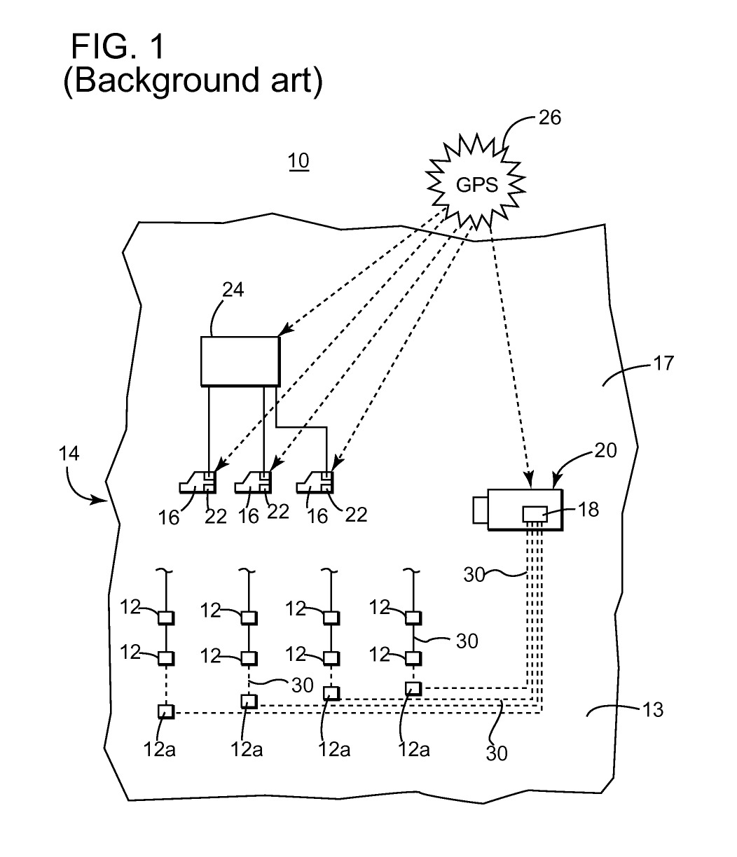

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures, or characteristics may be combined in any suitable manner in one or more embodiments.

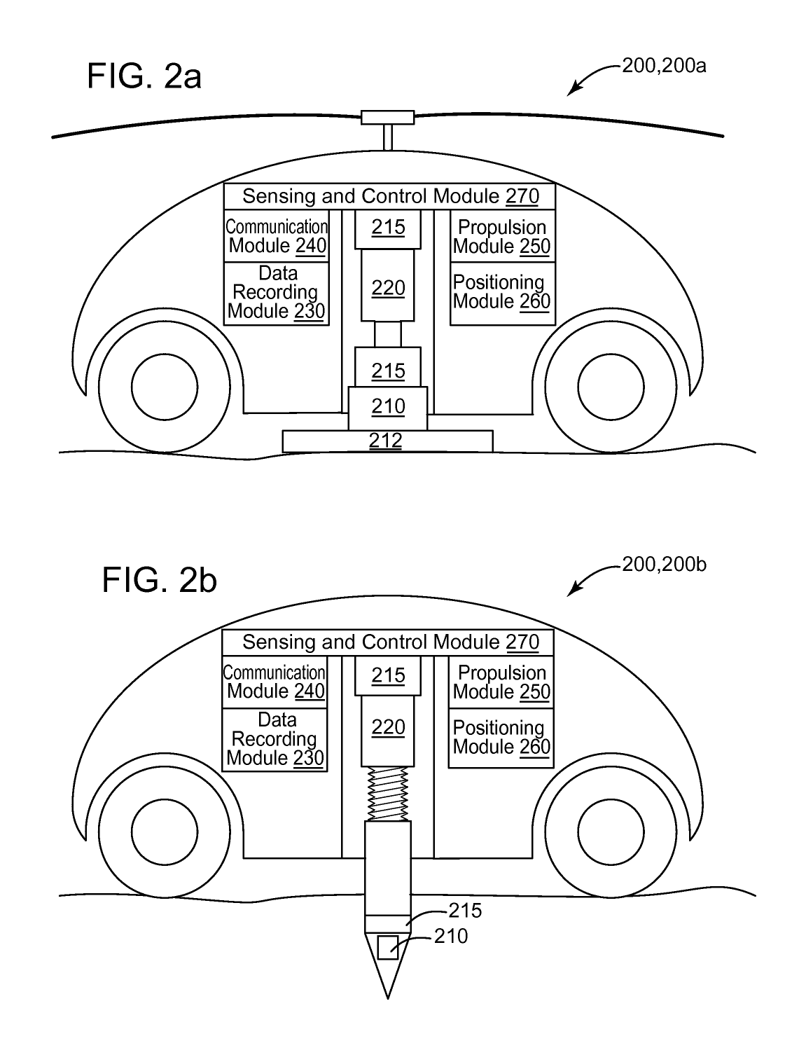

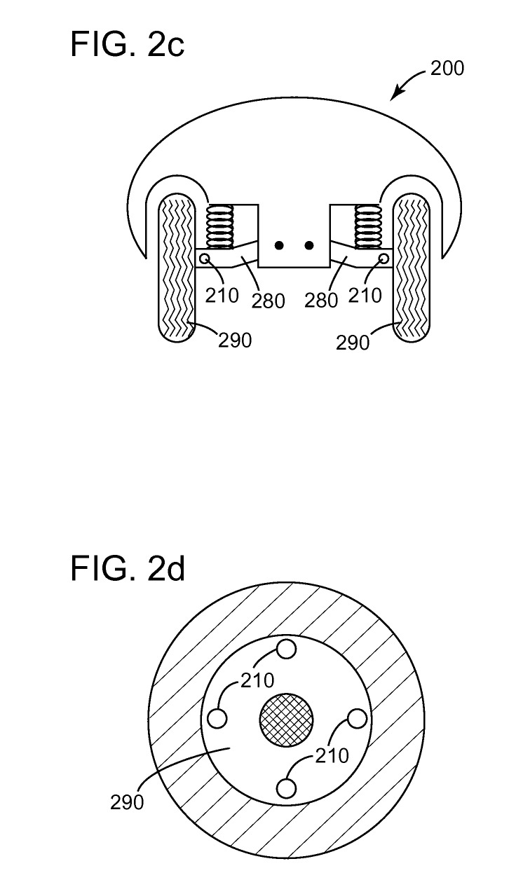

FIGS. 2a-2d are schematic diagrams depicting various embodiments of a drone seismic sensing apparatus. As depicted, the drone seismic sensing apparatus comprises a robotic transport unit 200 with one or more seismic sensing devices 210, one or more vibration isolators 215, an engagement/retraction unit 220, a data recording module 230, a communication module 240, a propulsion module 250, a positioning module 260, and a sensing and control module 270. The drone seismic sensing apparatus is useful for automated collection of geophysical data.

The seismic sensing device(s) 210 may detect seismic movement and provide seismic data. The seismic sensing device(s) 210 may be built into a portion of the robotic transport unit 200 or may be detachably coupled to the robotic transport unit 200. The seismic sensing device(s) 210 may be geophones, accelerometers, or the like. The seismic sensing device(s) 210 may be vibrationally isolated from the robotic transport unit 200 by the vibration isolator(s) 215 in order to reduce degradation of the seismic data provided by the seismic sensing device(s) 210. The vibration isolator(s) 215 may include a damping element (such as an airbag or a spring) or a damping material that vibrationally isolates a seismic sensing device 210 from the robotic transport unit 200. In some embodiments, a coupling plate 212 may improve coupling between the ground and the seismic sensing device(s) 210.

The engagement/retraction unit 220 may enhance vibrational coupling of the seismic sensing device(s) 210 with the ground by pressing the seismic sensing device(s) 210 against the ground as shown in FIG. 2a, or embedding the seismic sensing device(s) 210 into the ground as shown in FIG. 2b. The engagement/retraction unit 220 may also retract the seismic sensing device(s) 210 in order to facilitate moving the robotic transport unit 200 to another location. In some embodiments, a coupling plate 212 may improve coupling between the ground and the seismic sensing device(s) 210 when the coupling plate 212 is pressed against the ground by the engagement/retraction unit 220.

The data recording module 230 may record the seismic data provided by the seismic sensing device(s) 210 within a non-volatile memory such as a flash memory or a storage drive. In some embodiments, the seismic data provided by the seismic sensing device(s) 210 is immediately streamed to a recording unit (not shown) via wireless means (not shown). In other embodiments, the seismic data provided by the seismic sensing device(s) 210 is batch transferred to a recording unit in response to establishing an electrical or wireless connection between the communication module 240 and a recording unit.

The communication module 240 may send and receive messages, via wireless or non-wireless means, that facilitate automated and coordinated geophysical surveys. For example, the communication module 240 may communicate seismic data recorded by the data recording module 230. The wireless means may include one or more directional or omni-directional antennas (not shown). In certain embodiments, the robotic transport unit 200 may be oriented or moved to facilitate directive and/or line-of-sight wireless communications. For example, the robotic transport unit 200 may be reoriented and/or moved away from a survey route or a sensing location in order to avoid an obstacle that may be hindering wireless communications and subsequently oriented in a direction that facilitates remote control of the device 200 and/or line-of-sight communication with a recording station or the like.

The propulsion module 250 may drive and/or fly the robotic transport unit 200 to one or more selected locations or areas and enable the collection of seismic data from those locations or areas. The propulsion module 250 may be mechanically or otherwise coupled to one or more locomotion members such as wheels, tracks, turbines, and/or helicopter blades. For example, in certain embodiments the robotic transport unit is a quadcopter with 4 propulsion motors within the propulsion module 250 that are each mechanically coupled to a corresponding helicopter blade. In some embodiments, the propulsion module 250 enables both land-based locomotion as well as aerial locomotion (i.e., flight). In one embodiment, one or more seismic sensing devices 210 are integrated into the propulsion motor(s) within the propulsion module 250. For example, some or all of the coils of a propulsion motor may be monitored while the propulsion motor is not operating in order to detect rotational, horizontal, or vertical movement of a rotor portion of the motor relative to the stator portion. The direction and magnitude of the detected movement may be converted to seismic data useful for seismic analysis, or positional data useful for positioning and orientation.

The positioning module 260 may provide positional and orientation data for the robotic transport unit 200 that enables precise positioning and orientation of the robotic transport unit 200. The positioning module 260 may include a positioning device such as a GPS device that facilitates determining the position and/or orientation of the robotic transport unit 200 via reference signals provided by one or more sources such as GPS satellites. The positioning module 260 may also include one or more movement measurement devices such as accelerometers, compasses, rate of turn sensors, or the like that measure the relative movement of specific members of the robotic transport unit 200. The measured relative movements may be used to augment, improve, or replace data provided by the positioning device. Positional information from external devices such as other transport units may also be used to augment, improve, or replace the data provided by the positioning device.

In some embodiments, the movement measurement devices also function as the seismic sensing device(s) 210. For example, FIGS. 2c and 2d show examples of attaching or integrating seismic sensing device(s) 210 to one or more suspension members 280 or locomotion members 290 in a manner that also facilitates measuring movements of the robotic transport unit 200. In the depicted embodiment, the locomotion members 290 are solid round wheels that propagate movement from the earth to the seismic sensing device(s) 210 or movement measurement devices mounted thereon. In other embodiments, the locomotion members 290 may be tracks or multi-pedal wheels that have movement measurement devices and/or seismic sensing device(s) 210 mounted thereon. As depicted, the attached or integrated seismic sensing device(s) 210 may be vibrationally isolated from the body of the robotic transport unit 200 via the suspension members 280 in order to improve the quality of data provided by the device(s) 210.

The sensing and control module 270 may interface to a variety of sensors that facilitate intelligent control and movement of the robotic transport unit 200. For example, the sensing and control module 270 may interface to wind sensors, precipitation sensors, and humidity sensors (not shown) that provide information regarding environmental conditions. The information may be used to improve or condition the recorded seismic data. The information may also be used to determine a best expected path to a targeted location or area for seismic sensing.

The sensing and control module 270 may also interface to the positioning module 260 as well as the seismic sensing device(s) 210 and the data recording module 230. In some embodiments, the sensing and control module 270 also provides data to the data recording module 230, such as positioning data, that is appended to the recorded seismic data.

One of skill in the art will appreciate that the robotic transport unit 200 equipped in the manner described facilitates autonomous collection of seismic data for seismic surveys including high-density surveys which would be prohibitively time consuming using conventional techniques. One of skill in the art will appreciate that the various modules of the robotic transport unit 200 may comprise executable codes or interpreted statements that are processed by one or more digital processing units such as CPU's or microcontrollers. In one embodiment, a single digital processing unit is shared amongst all of the depicted modules.

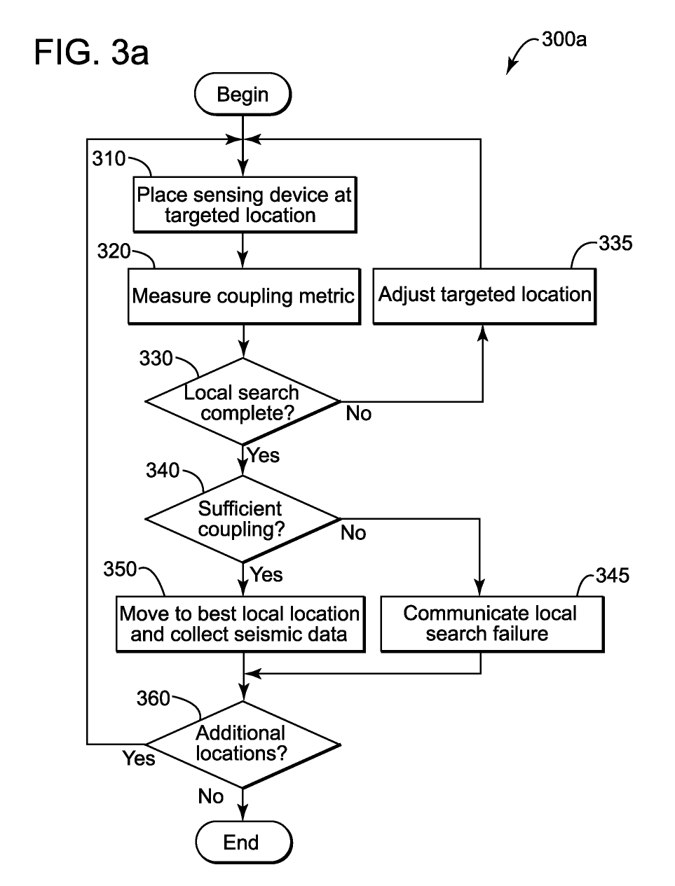

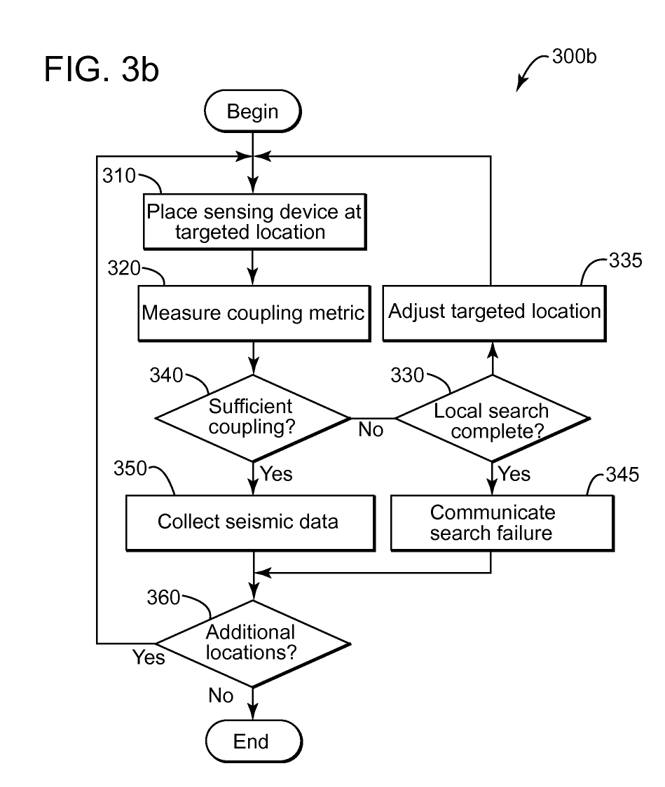

FIGS. 3a and 3b are flowchart diagrams of two embodiments of a drone seismic sensing method 300. As depicted, the drone seismic sensing method 300 includes placing 310 a sensing device at a targeted location, measuring 320 a coupling metric, determining 330 whether a local search is complete, adjusting 335 the targeted location, determining 340 whether there is sufficient coupling, communicating 345 that the local search has failed, collecting 350 seismic data, and determining 360 if additional locations are to be tested. While the drone seismic sensing method 300a depicted in FIG. 3a tests each targeted location within a search area to find the best location for collecting seismic data, the drone seismic sensing method 300b depicted in FIG. 3b tests each targeted location within the search area until a location with sufficient coupling is found, if any. In one embodiment, the level of coupling that is considered to be sufficient is a relative standard that is based on historical or current coupling data for locations that are proximate to each targeted location.

Placing 310 a sensing device at a targeted location may include deploying a robotic transport unit 200 at a deployment location and robotically guiding or driving the robotic transport to the targeted location. The robotic transport unit 200 may be autonomously driven or remotely guided by an operator. Placing 310 a sensing device at a targeted location may also include pressing the sensing device against, or embedding the sensing device into, the ground to facilitate the sensing of seismic movements within the ground at the targeted location.

Measuring 320 a coupling metric may include measuring how well the seismic sensing device is vibrationally coupled to the ground. In one embodiment, one or more seismic sources are activated and a coupling metric is derived from collected seismic data. In another embodiment, measurements are taken by driving a sensing coil within the sensing device with a driving signal (such as an impulse signal or step signal) and sensing the response within the sensing coil to the driving signal. Driving the sensing coil may include injecting an electrical current into the sensing coil or applying a voltage to the sensing coil. The response to the driving signal may include reflections and/or load responses that correlate to the vibrational coupling between the sensing device and the ground.

Determining 330 whether a local search is complete may include determining whether additional target locations remain that are proximate to (within a certain distance of) the initial target location. For example, a discrete number of target locations that are within a certain search zone may be tested for coupling and marked as tested after the measuring step 320. Adjusting 335 the targeted location may include changing to an untested target location within the search zone.

Determining 340 whether there is sufficient coupling may include determining whether a coupling metric is above a selected threshold. As depicted in the drone seismic sensing method 300a of FIG. 3a, the highest valued coupling metric that is found in a completed local search is tested against the selected threshold. As depicted in the drone seismic sensing method 300b of FIG. 3b, only the most recent coupling metric is tested against the selected threshold until a location with acceptable coupling is found or the local search is exhausted and no targeted location with sufficient coupling within the search area was found.

Communicating 345 that the local search has failed may include sending a message to a survey manager, or the like, that the drone seismic sensor was unable to find a location with good vibrational coupling within the search zone. In one embodiment, communicating that the local search has failed is accomplished by moving the drone seismic sensor to a selected location such as a service location.

Collecting 350 seismic data may include pressing the sensing device against, or embedding the sensing device into, the ground to facilitate the sensing of seismic movements within the ground at the targeted location. With the drone seismic sensing method 300a of FIG. 3a, collecting 350 seismic data also includes moving to the best local location found while completing the local search.

In some embodiments, collecting 350 seismic data may occur in response to activation, receiving notification of activation, or detecting activation, of a seismic source. In certain embodiments, the robotic transport unit 200 is also equipped with one or more seismic sources.

Determining 360 if additional locations are to be tested may include consulting a list of target locations or executing a search algorithm to determine if any target locations remain untested within the local search area.

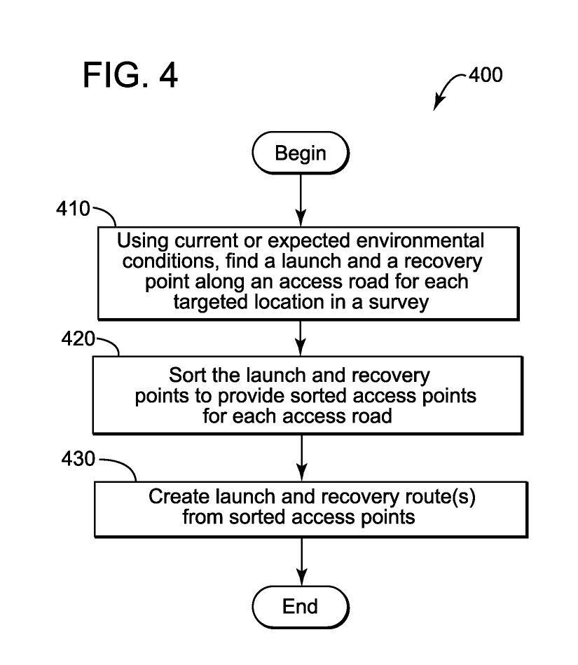

FIG. 4 is a flowchart diagram of a launch and recovery route planning method 400 for drone executed geophysical surveys. As depicted, the launch and recovery route planning method 400 includes finding 410 a launch and recovery point for each targeted location, sorting 420 the launch and recovery points to provide sorted access points, and creating 430 one or more launch and recovery routes from the sorted access points.

Finding 410 a launch and recovery point for each targeted location may include finding a launch point along an access road for each targeted location in a survey as well as finding a recovery point along the same or a different access road. In some embodiments, the location of the launch points and the recovery points are selected to correspond to the shortest distance to the access road. In other embodiments, the location of the launch points and the recovery points are selected to minimize an expected travel time between the launch or recovery point and the targeted location.

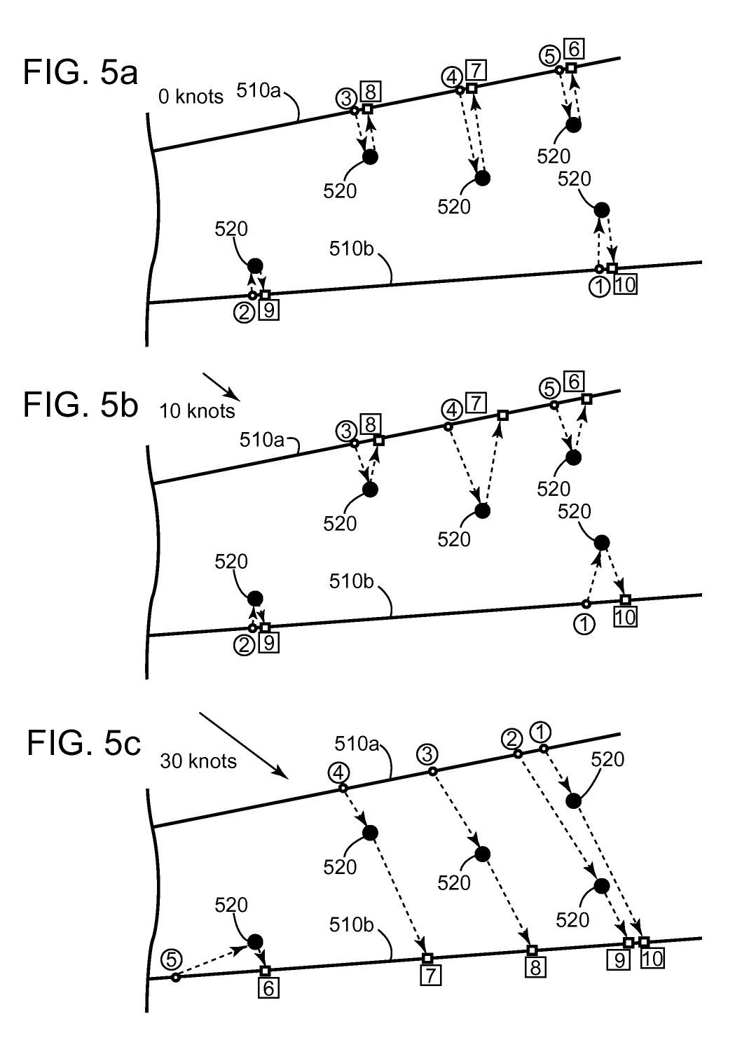

In yet other embodiments, the location of the launch points and the recovery points are selected to minimize an expected energy expenditure for traveling between the launch or recovery point and the targeted location which may or may not correspond to a shortest distance point or the minimum energy point from the access road to the targeted location. For example, the current or the expected environmental conditions, such as wind speed, precipitation, and water pooling, may be used to determine the launch and recovery points. Consequently, the launch point and the recovery point for a particular targeted location may be the same point along the same access road, different points along the same access road, or different points on different access roads. FIGS. 5a-5c show how the launch and recovery points may vary according to selected environmental conditions such as the expected average wind velocity in a survey area.

Returning to FIG. 4, sorting 420 the launch and recovery points to provide sorted access points may include sorting the launch and recovery points according to their distance along an access road. The launch points may be sorted in ascending or descending order to provide sorted access points for launching the drone seismic sensors. Similarly the recovery points may be sorted in descending or ascending order to provide sorted access points for recovering the drone seismic sensors. The sorting order of the launch and recovery points may be selected to be opposite each other in order to enable recovering the drone seismic sensors in a reverse order, or nearly reverse order, from which they are launched. Using an opposite sorting order may shorten the overall length of the combined launch and recovery routes.

Creating 430 one or more launch and recovery routes from the sorted access points may include using the sorted access points to determine a launching route and a recovery route for each launch and recovery vehicle used in a seismic survey.

FIGS. 5a-5c are schematic illustrations depicting example results for the route planning method of FIG. 4 for various environmental conditions. The depicted examples assume a single launch and recovery vehicle but may also be applicable to two or more launch and recovery vehicles. The depicted examples include routes for no wind, wind at 10 knots, and wind at 30 knots in the direction shown for FIGS. 5a, 5b and 5c, respectively. The example results show how a planned route may be dependent on environmental conditions.

In the depicted examples, the selected launch points along an access road 510 for each targeted location 520 are shown with small circles and the selected recovery points for each targeted location 520 are shown with small squares. Similarly, the selected launch route for each example is shown with larger circles numbered 1 through 5 and the selected recovery route is shown with larger squares numbered 6 through 10.

One of skill in the art will appreciate that with no wind velocity the selected launch points and recovery points may be the same for each targeted location 520 (although they are shifted slightly in FIG. 5a for clarity) but that location of the launch and recovery points may change with increasing wind speed for both land-based and aerial drones as shown in FIGS. 5b and 5c. In FIG. 5b, the launch point and the recovery point for each targeted location 520 are at different locations but on the same access road. In FIG. 5c, the recovery point for each targeted location 520 is on a lower access road 510b and the launch point for each targeted location 520 is on an upper access road 510a with the exception of the targeted location 520 that is closest to the lower access road 510b (shown on the lower left portion of FIG. 5c).

In the depicted examples, the expected wind velocity is assumed to be the same at the launch time and the recovery time for all of the seismic drones. However, an expected or current wind velocity may be estimated for each approximate launch and recovery location and time in order to better select the launch points and the recovery points and reduce the expected travel time or energy expenditure from the selected launch points to the targeted locations and from the targeted locations to the selected recovery points.

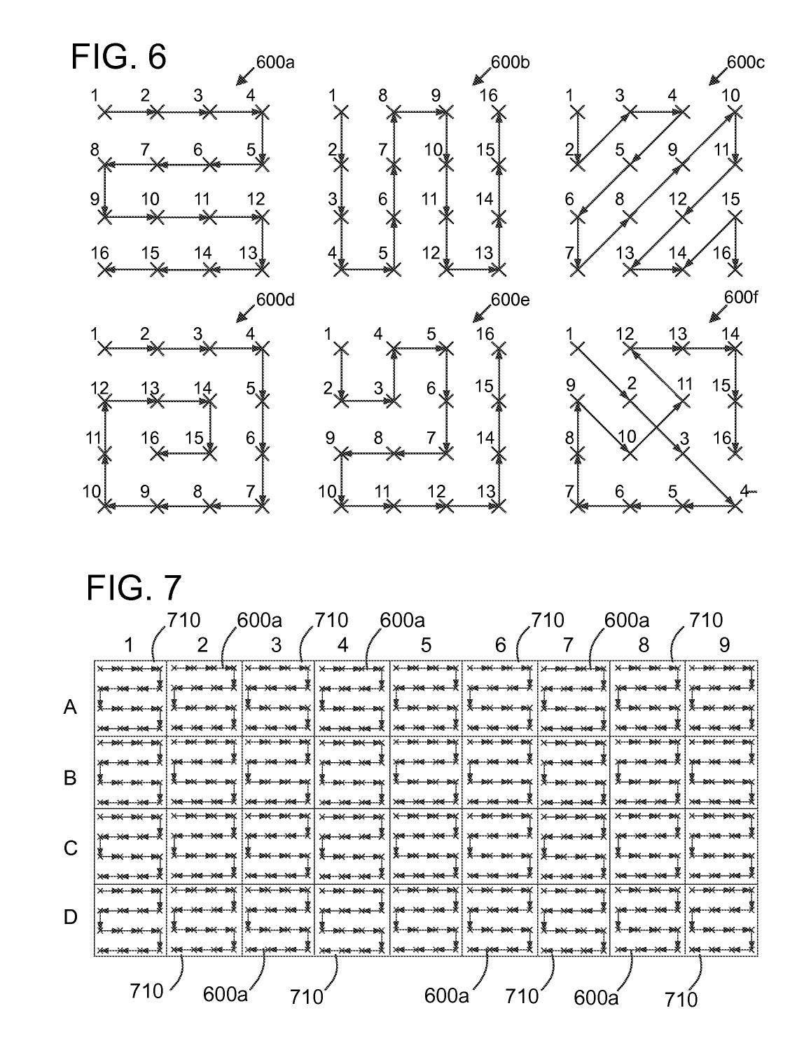

FIG. 6 is a schematic illustration of various high-density local-area survey patterns 600 for drone seismic sensors. Each of the high-density local-area survey patterns 600, or similar patterns, may be executed by one or more drone seismic sensors (e.g., the robotic transport unit 200 and associated elements) in conjunction with a seismic survey. The depicted survey patterns 600 include a number of targeted survey locations (shown with a ‘X’ symbol), arranged in various patterns including a horizontal serpentine pattern 600a, a vertical serpentine pattern 600b, a diagonal serpentine pattern 600c, a spiral pattern 600d, an expanding square pattern 600e, and crossing pattern 600f. The survey patterns 600 facilitate high-density automated surveys using drone seismic sensors. For example, in some embodiments the spacing between targeted survey locations is less than a few meters. One or more survey patterns may be executed according to a survey schedule. In some embodiments, locations that provided insufficient coupling for seimic data collection are detected (e.g., as described above) and skipped. In such instances, unused time for collecting seismic data at the inadequate location may be used at a subsequent survey location in order to collect as much seismic data as possible while maintaining the survey schedule. In some embodiments, information on the adequacy of survey locations is used to dynamically or statically adjust a survey route.

FIG. 7 is a schematic illustration of one example of a high-density large-area survey pattern 700 for drone seismic sensors. The high-density large-area survey pattern may be executed by dispatching a drone seismic sensor to each grid area 710 and executing a survey pattern 600, or a similar pattern, within that grid area. In the depicted embodiment, the high-density large-area survey pattern 700 comprises a 4×9 grid of grid areas 710 and the horizontal serpentine pattern 600a is executed within each grid area 710. The rows of the 4×9 grid are labeled A to D and the columns are labeled 1-9. Two or more of the survey patterns 600 within the grid areas 710 may be concurrently executed by dispatching a drone seismic sensor to each grid area 710 that is to be concurrently executed. The number of survey patterns 600 that are concurrently executed may be dependent on the number of drone seismic sensors that are available.

It should be noted that some of the functional units described herein are explicitly labeled as modules while others are assumed to be modules. One of skill in the art will appreciate that the various modules described herein may include a variety of hardware components that provide the described functionality including one or more processors such as CPUs or microcontrollers that are configured by one or more software components. The software components may include executable instructions or codes and corresponding data that are stored in a storage medium such as a non-volatile memory, or the like. The instructions or codes may include machine codes that are configured to be executed directly by the processor. Alternatively, the instructions or codes may be configured to be executed by an interpreter, or the like, that translates the instructions or codes to machine codes that are executed by the processor.

It should also be understood that this description is not intended to limit the invention. On the contrary, the exemplary embodiments are intended to cover alternatives, modifications, and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for automated seismic sensing, the method comprising:
transporting a seismic sensing device to a targeted location with a robotic transport device;
placing the seismic sensing device in vibrational communication with the ground; and
sensing seismic data with the seismic sensing device.

2. The method of claim 1, further comprising pressing the seismic sensing device against the ground, or embedding the seismic sensing device into the ground, concurrent with sensing the seismic data with the seismic sensing device.

3. The method of claim 1, further comprising determining a coupling metric for the seismic sensing device and the ground.

4. The method of claim 3, further comprising determining if the coupling metric is acceptable for seismic sensing.

5. The method of claim 4, further comprising adjusting the targeted location if the coupling metric is not acceptable for seismic sensing.

6. The method of claim 4, further comprising communicating if the targeted location is acceptable for seismic sensing.

7. The method of claim 1, further comprising advancing to another targeted location.

8. The method of claim 1, further comprising executing a survey route comprising a plurality of targeted locations.

9. The method of claim 8, wherein the survey route comprises a serpentine pattern.

10. The method of claim 1, further comprising adjusting an orientation or a current position for the robotic transport unit to facilitate directive communications.

11. The method of claim 1, further comprising determining a launching or recovery point on an access road proximate to the targeted location.

12. The method of claim 11, wherein the launching or recovery point minimizes an expected energy expenditure for traveling between the launching or recovery point and the targeted location.

13. An apparatus for automated seismic sensing, the apparatus comprising:
a seismic sensing device for sensing seismic vibrations and providing seismic data corresponding to seismic vibrations;
a robotic transport unit for transporting the seismic sensing device to a targeted location;
an engagement unit for placing the seismic sensing device in vibrational communication with the ground; and
a recording module for recording the seismic data generated by the seismic sensing device.

14. The apparatus of claim 13, wherein the engagement unit is further configured to embed the seismic sensing device into the ground or press the seismic sensing device against the ground while the seismic sensing device is sensing the seismic data.

15. The apparatus of claim 13, further comprising a vibration isolator for isolating vibrations in the robotic transport unit from the seismic sensing device.

16. The apparatus of claim 15, wherein the vibration isolator comprises an airbag.

17. The apparatus of claim 13, wherein the robotic transport unit comprises a locomotion member and the seismic sensing device is attached to the locomotion member or a suspension member of the robotic transport device.

18. The apparatus of claim 13, wherein the robotic transport unit comprises a propulsion module.

19. The apparatus of claim 18, wherein the seismic sensing device is integrated into the propulsion module.

20. A method for automated seismic sensing, the method comprising:
transporting a seismic sensing device to a targeted location with a robotic transport device;
determining a coupling metric for the seismic sensing device and the ground at a plurality of locations proximate to the targeted location until an acceptable location for seismic sensing is found;
placing the seismic sensing device in vibrational communication with the ground at the acceptable location; and
sensing seismic data with the seismic sensing device at the acceptable location.
